(19) United States
(12) Patent Application Publication
(10) Pub. No.: US 2013/0100091 A1
(43) Pub. Date: Apr. 25, 2013

(54) DISPLAY DEVICE

(71) Applicant: Japan Display East Inc., Chiba-ken (JP)

(72) Inventors: Yasukazu KIMURA, Chiba (JP); Katsumi MATSUMOTO, Mobara (JP)

(73) Assignee: JAPAN DISPLAY EAST INC., Chiba-ken (JP)

(21) Appl. No.: 13/654,543

(22) Filed: Oct. 18, 2012

(30) Foreign Application Priority Data
Oct. 19, 2011 (JP) 2011-229641

(51) Int. Cl. G06F 3/038

(52) U.S. Cl. 345/204

(57) ABSTRACT

An edge of the dummy opening includes an edge formed of a part of an edge of the stationary opening assumed to be arranged in the peripheral area with regularity of the stationary openings. The shutter in the display area makes the driven opening and the stationary opening be communicated with each other to transmit light at the first position, and is disposed so that the driven opening and the stationary opening are shifted from each other to block the light at the second position. In the case in which the shutters are located in the second position, the distance between the driven opening and the edge in the peripheral area and the distance between the driven opening and a part of an edge of the stationary opening in the display area have a correlative relationship with each other.

### CROSS-REFERENCE TO RELATED APPLICATION

The present application claims priority from Japanese application JP2011-229641 filed on Oct. 19, 2011, the contents of which are hereby incorporated by reference into this application.

### BACKGROUND OF THE INVENTION

1. Field of the Invention

The present invention relates to a display device.

2. Description of the Related Art

Micro-electromechanical system displays (MEMS displays) are displays expected to replace liquid crystal displays (see JP 2008-197668 A). Unlike the liquid crystal shutter system using polarized light, these displays open and close the light transmission windows using a mechanical shutter system to thereby display an image.

The shutter has driven openings, and is arranged to be driven while being attached to a substrate. Another substrate provided with a light-blocking film is disposed so as to be opposed to this substrate, and the light-blocking film is provided with stationary openings. When driving the shutter, the light is transmitted if the driven openings and the stationary openings are matched each other, and the light is blocked if they are shifted from each other, which makes an ON-OFF action of one pixel possible.

In the MEMS display of the related art, it is not achievable to check how much the driven openings and the stationary openings are shifted from each other when the shutter blocks the light. Although the light can be blocked in a vertical direction providing the driven openings and the stationary openings are shifted from each other in the vertical direction, in order to prevent the light from being obliquely leaked, it is necessary to assure the shift amount set previously. Since the shift amount affects the view angle dependency of the contrast, and further, the light leakage might also be caused at worst if the displacement due to the bonding of the both substrates is large, it is important to make it possible to perform screening with an inspection.

### SUMMARY OF THE INVENTION

The present invention has an object of providing a structure of making it possible to detect the shift amount between the driven openings and the stationary openings.

1. A display device according to the invention includes a first substrate having a light transmissive property, a light-blocking film provided to the first substrate, a second substrate having a light transmissive property, disposed so as to be opposed to the first substrate with a space, a plurality of shutters provided to the second substrate, and a plurality of drive sections provided to the second substrate, and adapted to move the respective shutters between a first position and a second position, an area where the first substrate and the second substrate overlap each other includes a display area and a peripheral area surrounding the display area, the plurality of shutters are arranged in the display area and the peripheral area, each of the shutters has at least one driven opening moving in conjunction with a movement of the shutter, a whole of the plurality of shutters has a plurality of the driven openings, the light-blocking film is formed in the display area and the peripheral area, the light-blocking film has a plurality of stationary openings in the display area so as to correspond to the driven openings in the display area, each of the shutters in the display area makes the driven opening and the stationary opening be communicated with each other to transmit light at the first position, and is disposed so that the driven opening and the stationary opening are shifted from each other to block the light at the second position, and the light-blocking film has, in the peripheral area, a dummy opening adapted to partially expose at least one of the shutters arranged in the peripheral area. According to the present invention, since the light is blocked if the shutter is located at the second position, it is not achievable to measure the shift amount between the driven opening and the stationary opening in the display area. However, if it is possible to measure the distance between the edge of the dummy opening and the driven opening in the peripheral area, the shift amount between the driven opening and the stationary opening can be detected in accordance with the distance measured.

2. In the display device according to Section 1, it is also possible that the plurality of driven openings are arranged with regularity in the entire display area and peripheral area, the plurality of stationary openings are arranged with regularity corresponding to the regularity of the plurality of driven openings, and in a case in which the plurality of shutters are located at the second position, a distance between the driven opening and an edge of the dummy opening in the peripheral area and a distance between the driven opening and a part of an edge of the stationary opening in the display area have a correlative relationship with each other.

3. In the display device according to Section 2, it is also possible that the edge of the dummy opening includes an edge formed of a part of an edge of the stationary opening, which is assumed to be arranged in the peripheral area with the regularity of the plurality of stationary openings.

4. In the display device according to any one of Sections 1 through 3, it is also possible that in a case in which the plurality of shutters are located at the second position, a distance between the driven opening and an edge of the dummy opening in the peripheral area and a distance between the driven opening and a part of an edge of the stationary opening in the display area are equal to each other.

5. In the display device according to any one of Sections 1 through 4, it is also possible that an edge of the dummy opening is a part of the stationary opening.

6. In the display device according to any one of Sections 1 through 5, it is also possible that the driven openings are each formed so as to extend in a direction intersecting with a direction between the first position and the second position, and in a case in which the shutter in the display area is located at the second position, the stationary opening in the display area is located at a position shifted from the driven opening in a direction between the first position and the second position.

7. In the display device according to Section 6, it is also possible that in a case in which the shutter in the peripheral area is located at the second position, an edge of the dummy opening is located at a position shifted from an edge of the driven opening in the direction between the first position and the second position.

8. In the display device according to Section 6, it is also possible that in the case in which the shutter in the peripheral area is located at the second position, an edge of the dummy opening is located at a position shifted from an edge of the driven opening in a direction in which the driven opening extends.

9. In the display device according to Section 6, it is also possible that an edge of the dummy opening includes a first edge and a second edge, in a case in which the shutter in the peripheral area is located at the second position, the first edge is located at a position shifted from an edge of the driven opening in the direction between the first position and the second position, and in the case in which the shutter in the peripheral area is located at the second position, the second edge is located at a position shifted from an edge of the driven opening in a direction in which the driven opening extends.

10. In the display device according to any one of Sections 1 through 6, it is also possible that the shutters in the peripheral area include a first shutter and a second shutter, and the light-blocking film is formed so as to always cover a whole of the driven opening of the first shutter irrespective of the position of the first shutter, and to expose a part of an edge of the driven opening of the second shutter from the dummy opening in a case in which the second shutter is located at the second position.

11. In the display device according to Section 10, it is also possible that in a case in which the second shutter is located at the second position in the peripheral area, an edge of the light-blocking film overlaps a substrate of the second shutter.

12. In the display device according to Section 10, it is also possible that in a case in which the second shutter is located at the second position in the peripheral area, an edge of the light-blocking film overlaps the driven opening of the second shutter.

13. In the display device according to Section 10, it is also possible that in a case in which the second shutter is located at the second position, an edge of the light-blocking film includes a first edge overlapping a substrate of the second shutter and a second edge overlapping the driven opening of the second shutter.

14. In the display device according to any one of Sections 1 through 3, it is also possible that the display area and the peripheral area are each formed to have a rectangular shape, and the dummy opening is provided to each of four corners of the peripheral area.

### BRIEF DESCRIPTION OF THE DRAWINGS

FIG. 1 is a cross-sectional view of a display device according to an embodiment of the invention.

FIG. 2 is a plan view of a first substrate.

FIG. 3 is a plan view of a second substrate.

FIG. 4 is a perspective view of a shutter and a drive section thereof.

FIG. 5 is a diagram showing the positions of stationary openings and driven openings in a display area.

FIG. 6 is a diagram showing the positions of dummy openings and the driven openings in a peripheral area.

FIG. 7 is an enlarged view showing the positions of the dummy openings and the driven openings.

FIG. 8 is a diagram for explaining an electronic apparatus incorporating the display device according to the present embodiment.

FIG. 9 is a diagram for explaining a modified example of the electronic apparatus.

FIG. 10 is a diagram showing the dummy openings according to the modified example.

FIG. 11 is an enlarged view showing the positions of the dummy openings and the driven openings according to the modified example.

### DETAILED DESCRIPTION OF THE INVENTION

Some embodiments of the invention will hereinafter be explained with reference to the accompanying drawings.

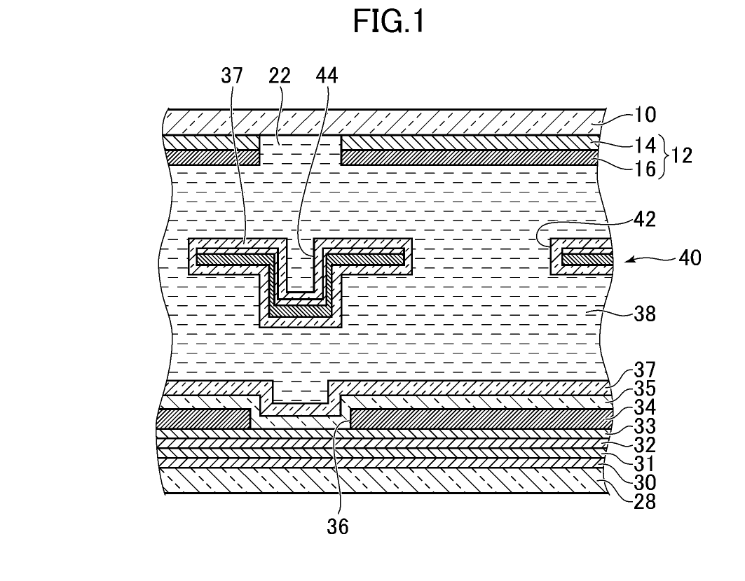

FIG. 1 is a cross-sectional view of a display device according to the embodiment of the invention. The display device has a first substrate 10 (e.g., a glass substrate) having a light transmissive property. The first substrate 10 is provided with a light-blocking film 12. The light-blocking film 12 is composed of at least one layer of metal film (e.g., an Al-series metal film 14 and an Mo-series metal film 16), and has a thickness necessary for blocking the transmission of the light.

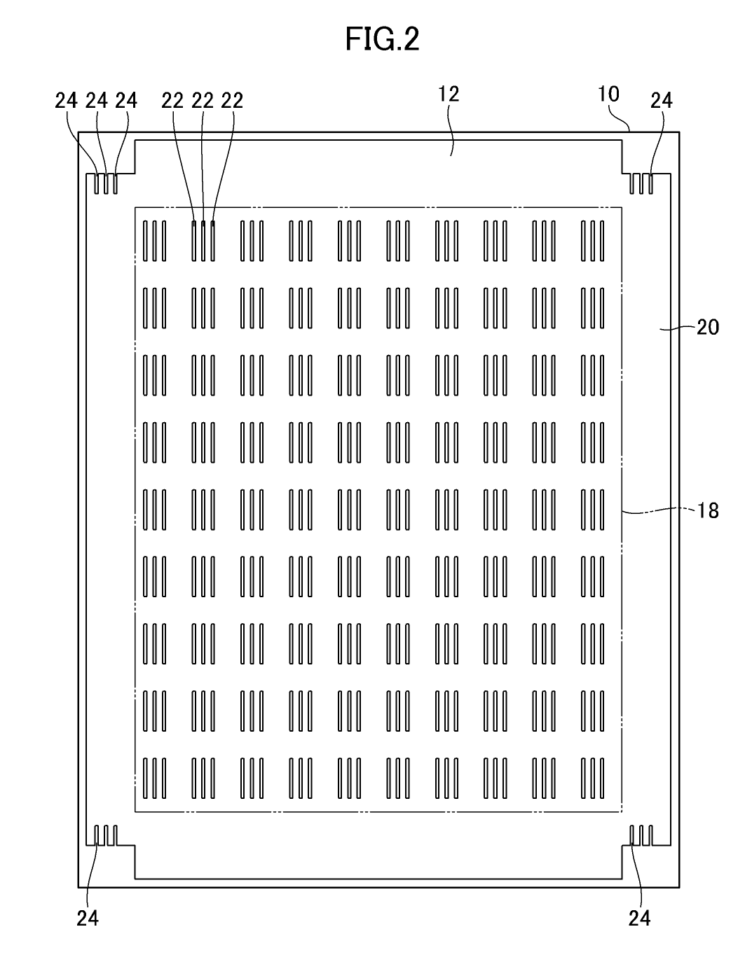

FIG. 2 is a plan view of the first substrate 10. The first substrate 10 has a display area 18 for displaying an image, and a peripheral area 20 surrounding the display area 18. The peripheral area 20 is an area surrounding the display area 18. The peripheral area 20 surrounding the rectangular display area 18 has a rectangular outer shape. The light-blocking film 12 is provided to the display area 18 and the peripheral area 20. In a detailed explanation, the light-blocking film 12 is formed throughout the entire display area 18, but is formed in the peripheral area 20 so as to avoid the edges of the first substrate 10. In the example shown in FIG. 2, the light-blocking film 12 is provided with cutouts formed at positions corresponding to the four corners of the first substrate 10.

The light-blocking film 12 has a plurality of stationary openings 22 in the display area 18. The stationary opening 22 is a slit elongated in one direction. The plurality of stationary openings 22 are arranged to extend in parallel to each other. The plurality of stationary openings 22 are arranged with regularity. For example, a predetermined number (three in FIG. 2) of stationary openings 22 form one group, and a plurality of groups of stationary openings 22 are arranged in a matrix with a plurality of rows and a plurality of columns. The intervals between the groups adjacent to each other are equal in the lateral direction (the row direction), and the intervals between the groups adjacent to each other are also equal in the vertical direction (the column direction).

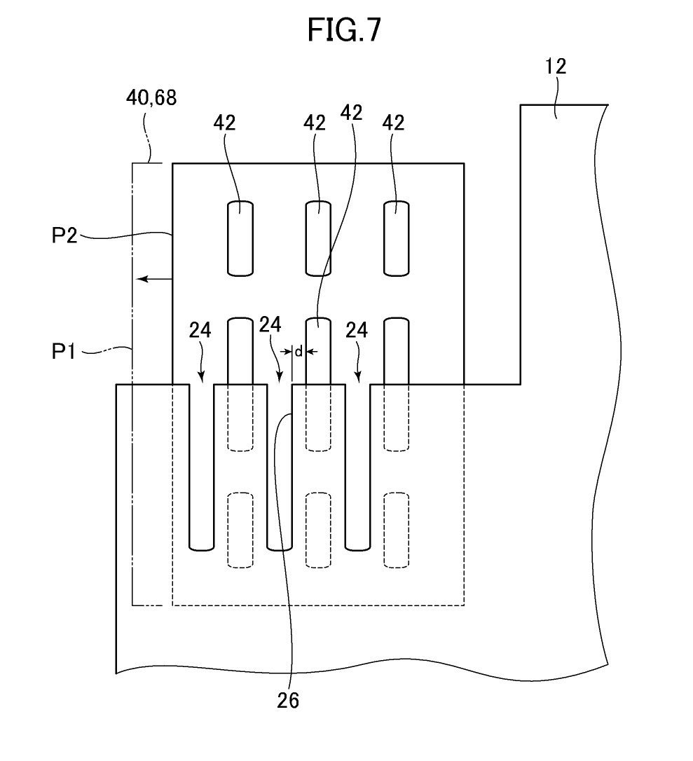

The light-blocking film 12 has dummy openings 24 in the peripheral area 20. The dummy openings 24 shown in FIG. 2 are each a cutout, but can also be a hole (an opening). An edge 26 (see FIG. 7) of the dummy opening 24 corresponds to a part of the stationary opening 22. In other words, the dummy opening 24 has a shape obtained by cutting the stationary opening 22. Each of the dummy openings 24 is an elongated cutout having a shape obtained by cutting the slit, and the plurality of cutouts are arranged to extend in parallel to each other. A predetermined number (three in FIG. 2) of dummy openings 24 are formed so as to form one group. A group of dummy openings 24 is formed on each of the four corners of the first substrate 10 having a rectangular shape.

The arrangement of the dummy openings 24 follows the regularity of the arrangement of the stationary openings 22. In other words, assuming that stationary openings 22 are disposed also in the peripheral area 20 with the regularity of the plurality of stationary openings 22, the dummy openings 24 are formed at the positions coinciding with the stationary openings 22. The edge of the dummy opening 24 includes the edge 26 (see FIG. 7) consisting of a part of the edge of the virtual stationary opening 22.

As shown in FIG. 1, the display device has a second substrate 28 (e.g., a glass substrate) having a light transmissive property. The second substrate 28 is disposed so as to be opposed to the first substrate 10 with a space. The second substrate 28 is a circuit board provided with thin film transistors and wiring not shown or a thin film transistor (TFT) substrate. On the second substrate 28, there are stacked a foundation SiN film 30, a foundation SiO film 31, a gate insulating film 32, and a first interlayer insulating film 33 each having a light transmissive property, an internal light-blocking plate 34 for blocking the light is formed thereon, a second interlayer insulating film 35 having a light transmissive property is stacked thereon, and a passivation film 37 having a light transmissive property is stacked thereon. The internal light-blocking plate 34 is provided with openings 36 for transmitting the light.

The first substrate 10 and the second substrate 28 are fixed to each other with a space formed by a seal member not shown. The space (the space sealed by the seal member not shown) between the first substrate 10 and the second substrate 28 is filled with oil 38 (e.g., a silicone oil).

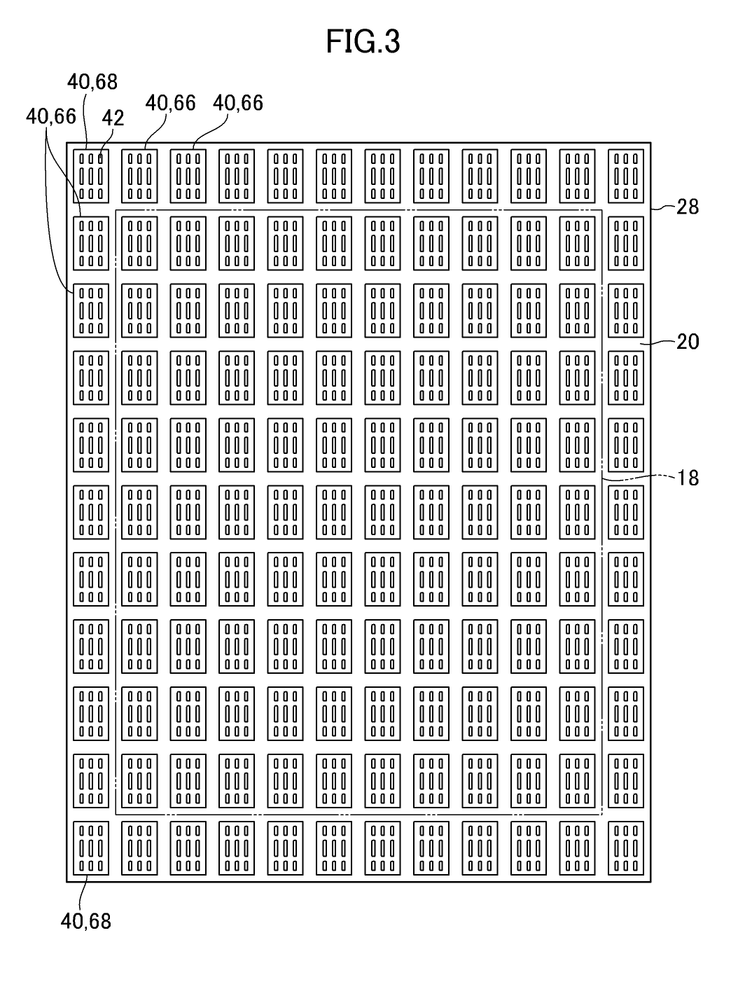

FIG. 3 is a plan view of the second substrate 28. The second substrate 28 is provided with a plurality of shutters 40. The second substrate 28 also includes the display area 18 for displaying an image, and the peripheral area 20 surrounding the display area 18 in an overlap area with the first substrate 10. The plurality of shutters 40 are disposed in the display area 18 and the peripheral area 20.

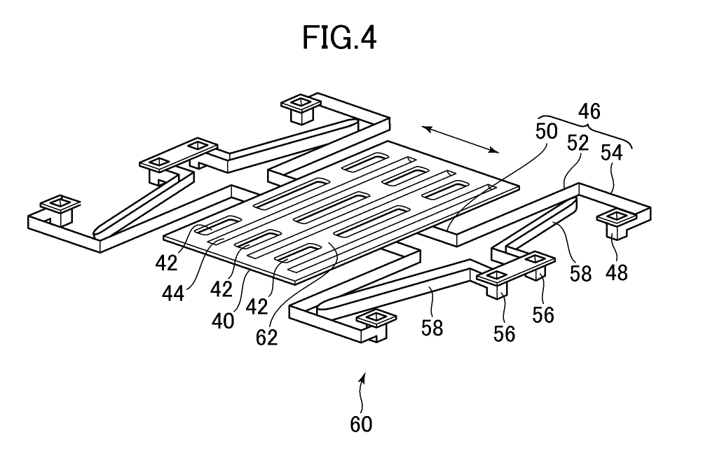

FIG. 4 is a perspective view of the shutter 40 and a drive section thereof. The shutter 40 is made of an inorganic material. The shutter 40 is a plate having driven openings 42. Further, the shutter 40 is provided with recessed sections 44 in order to enhance the strength, but the recessed sections 44 do not penetrate the plate. The light passes through the driven openings 42, and the light is blocked by the part other than the driven openings 24.

The shutter 40 is supported by first springs 46, and is arranged to be lifted from the second substrate 28 as shown in FIG. 1. The shutter 40 is supported by a plurality of (four in FIG. 4) first springs 46. The first springs 46 are each fixed to the second substrate 28 at a first anchor section 48.

The first spring 46 is formed of an elastically deformable material. The first spring 46 has a plate-like shape with a small thickness, and is disposed so that the thickness direction is aligned in the lateral direction (a direction parallel to the surface of the second substrate 28), and the width direction is aligned in the vertical direction (a direction perpendicular to the surface of the second substrate 28). Thus, the first spring 46 is arranged to be able to deform in the lateral direction, namely the thickness direction thereof.

The first spring 46 has a first section 50 extending in a direction (a direction intersecting with (e.g., perpendicular to) the length direction of the driven opening 42) of getting away from the shutter 40, a second section 52 extending in a direction along the length direction of the driven opening 42 from the center of the driven opening 42 in the length direction toward the outside, and a third section 54 extending in a direction (a direction intersecting with (e.g., perpendicular to) the length direction of the driven opening 42) of further getting away from the shutter 40. Further, as indicated with the arrow in FIG. 4, the shutter 40 is supported by the first springs 46 so as to be able to move in a direction intersecting with (e.g., perpendicular to) the length direction of the driven opening 42.

The second substrate 28 is provided with second springs 58 each supported by a second anchor section 56. The second spring 58 is also formed of an elastically deformable material. The second spring 58 has a plate-like shape with a small thickness, and is disposed so that the thickness direction is aligned in the lateral direction (a direction parallel to the surface of the second substrate 28), and the width direction is aligned in the vertical direction (a direction perpendicular to the surface of the second substrate 28). Thus, the second spring 58 is arranged to be able to deform in the lateral direction, namely the thickness direction thereof. Further, the second spring 58 has a looped form, and is arranged so that a band-like portion extending from the second anchor section 56 is bent, and folded to return to the same second anchor section 56.

The second spring 58 is arranged to be opposed to the second section 52 of the first spring 46 on the side further from the shutter 40 than the second section 52. It is arranged that by applying a voltage to the second anchor section 56, the second section 52 is attracted by the second spring 58 due to the electrostatic attractive force caused by the potential difference from the second section 52 of the first spring 46. If the second section 52 is attracted, the shutter 40 is also attracted via the first section 50 integrated with the second section 52. In other words, the first spring 46 and the second spring 58 are for constituting a drive section 60 for mechanically driving the shutter 40. The drive section 60 is formed of the same material as the material of at least a part of the shutter 40.

It should be noted that as shown in FIG. 1, the shutters 40 and the drive sections 60 are disposed in the oil 38. The oil 38 can suppress the vibration caused by the movement of the shutter 40 and the drive section 60, and can also prevent the fixation between the first spring 46 and the second spring 58.

The shutter 40 has at least one driven opening 42. The driven opening 42 has a shape elongated in one direction, but is divided into a plurality of parts because bridges 62 and the recessed sections 44 for preventing the deformation of the shutter 40 and the shapes of the openings are provided. In this case, two or more driven openings 42 are arranged perpendicular to the length direction in each of the shutters 40. The driven openings 42 adjacent to each other are arranged to be parallel to each other.

As shown in FIG. 3, the plurality of shutters 40 have the plurality of driven openings 42 as a whole. The plurality of driven openings 42 are arranged with regularity in the entire display area 18 and peripheral area 20. For example, the plurality of shutters 40 are arranged in a matrix with a plurality of rows and a plurality of columns. The arrangement rule of the shutters 40 arranged in the display area 18 and the arrangement rule of the shutters arranged in the peripheral area 20 are the same. Further, it is designed that the shapes and the arrangement of the two or more driven openings 42 provided to each of the shutters 40 are also the same between the shutters 40.

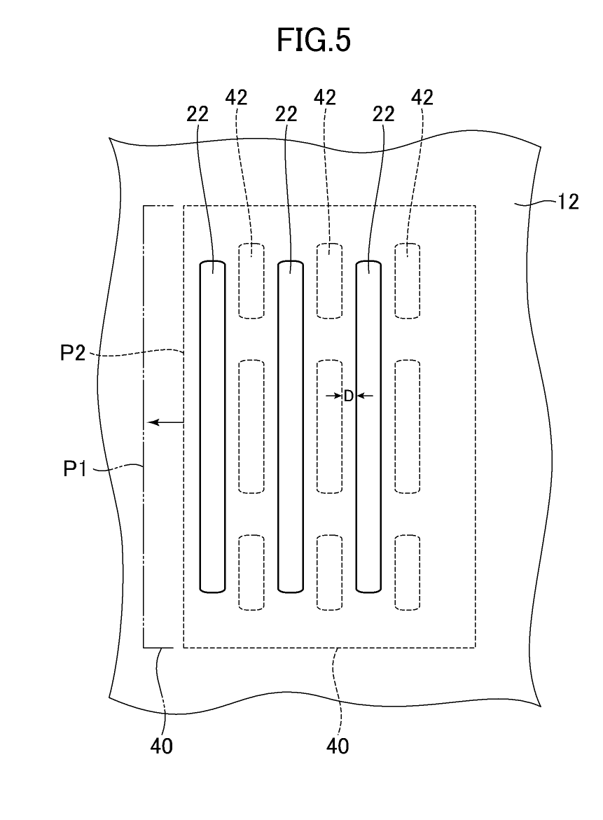

FIG. 5 is a diagram showing the positions of the stationary openings 22 and the driven openings 24 in the display area 18. The regularity of the arrangement of the plurality of stationary openings 22 corresponds to the regularity of the arrangement of the plurality of driven openings 42. In other words, it is arranged that the driven openings 42 and the stationary openings 22 correspond to each other in the display area 18.

The shutter 40 moves between a first position P1 and a second position P2 due to the drive section 60. Each of the plurality of driven openings 42 is formed so as to extend in a direction intersecting with the direction between the first position P1 and the second position P2.

When the driven opening 42 of the shutter 40 and the stationary opening 22 of the light-blocking film 12 are communicated with each other, the light passes therethrough. The shutters 40 in the display area 18 each make the driven openings 42 and the stationary openings 22 be communicated with each other at the first position P1 to thereby transmit the light. If the stationary openings 22 of the light-blocking film 12 are closed due to the movement of the shutter 40, the light is blocked. The shutters 40 in the display area 18 are each disposed so that the driven opening 42 and the stationary opening 22 are shifted from each other to thereby block the light at the second position P2. In this case, the stationary openings 22 are displaced from the driven openings 24 in the direction (the moving direction of the shutter 40) between the first position P1 and the second position P2. The amount of the displacement is important for blocking the light.

The shutters 40 are each mechanically driven to thereby control transmission and blocking of the light to the stationary openings 22 of the light-blocking film 12. It is arranged that each pixel is constituted by the driven openings 42 and the stationary openings 22 corresponding to one shutter 40, and the image is displayed by a number of pixels. Therefore, there are disposed a plurality of (a number of) shutters 40. The shutters 40 and the drive sections 60 are arranged in the display area 18 for displaying an image using presence or absence, and an intensity level of the light transmitted through the driven openings 42 and the stationary openings 22.

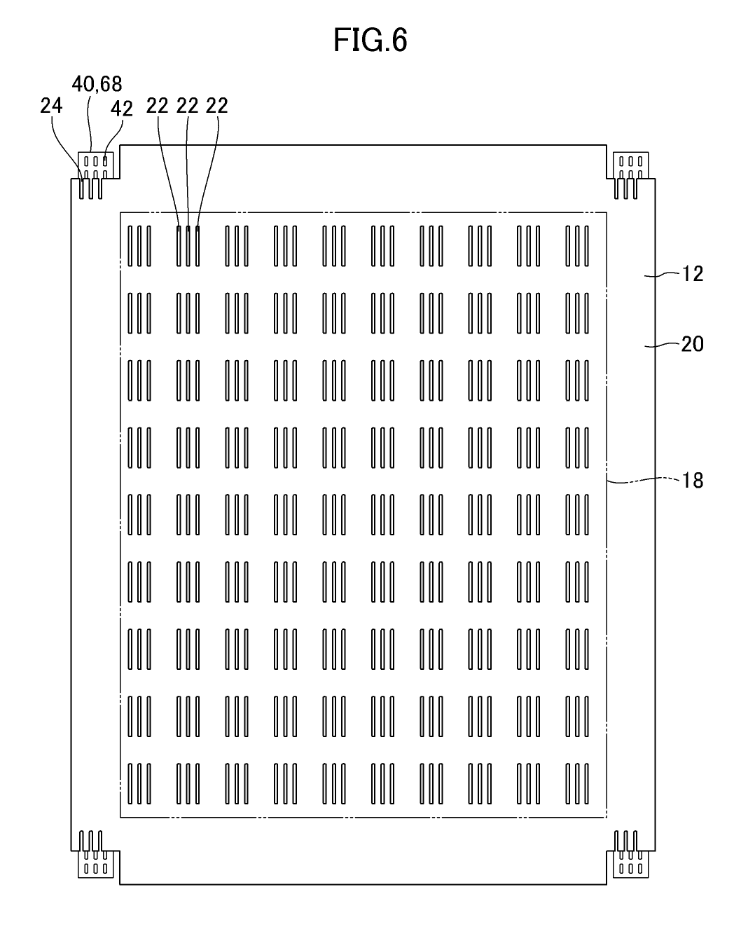

FIG. 6 is a diagram showing the positions of the dummy openings 24 and the driven openings 42 in the peripheral area 20. As shown in FIG. 3, the shutters 40 in the peripheral area 20 include first shutters 66. As shown in FIG. 6, the light-blocking film 12 always covers the entire driven openings 42 of the first shutter 66 irrespective of the position of the first shutter 66. In other words, the shutters 40 always covered by the light-blocking film 12 in the peripheral area 20 are the first shutters 66.

As shown in FIGS. 3 and 6, the shutters 40 in the peripheral area 20 include second shutters 68. As shown in FIG. 6, the light-blocking film 12 is formed so as to avoid duplication with a part of the second shutter 68 in the peripheral area 20. In other words, in the peripheral area 20, a part of the second shutter 68 is exposed from the light-blocking film 12.

FIG. 7 is an enlarged view showing the positions of the dummy openings 24 and the driven openings 42. When the second shutter 68 is located at the second position P2, the edge 26 of the dummy opening 24 overlaps the substrate of the second shutter 68. It should be noted that as shown in FIG. 5, in the display area 18, when the shutter 40 is located at the second position P2, the driven opening 42 overlaps the substrate of the shutter 40.

The edge 26 of the dummy opening 24 can visually be recognized on the substrate of the second shutter 68 due to the difference in reflectance or the difference in color between the light-blocking film 12 and the second shutter 68. Further, in this case, a part of the edge of the driven opening 42 of the second shutter 68 is exposed from the light-blocking film 12.

In the case in which the second shutter 68 is located at the second position P2, the edge 26 of the dummy opening 24 is located at a position shifted in the direction (the driving direction of the shutter 40) between the first position P1 and the second position P2 from the edge of the driven opening 42. The shift amount thereof corresponds to the shift amount of the stationary opening 22 and the driven opening 42 when arranging the virtual stationary openings 22 so as to match the dummy openings 24. It should be noted that the edge 26 of the dummy opening 24 extends in a direction perpendicular to the moving direction of the shutter 40.

As is understood from FIGS. 5 and 7, in the case in which a plurality of shutters 40 are located at the second position P2, the distance d (FIG. 7) between the driven opening 42 and the edge 26 in the peripheral area 20 and the distance D (FIG. 5) between the driven opening 42 and apart of the edge of the stationary opening 22 in the display area 18 have a correlative relationship. For example, the distances are equal to each other. Therefore, by measuring the distance d between the driven opening 42 and the edge 26 in the peripheral area 20, it is possible to figure out the distance D between the driven opening 42 and the part of the edge of the stationary opening 22 in the display area 18. In other words, the shift amount between the stationary opening 22 and the driven opening 42 can be figured out.

According to the present embodiment, since the light is blocked if the shutter 40 is located at the second position P2, it is not achievable to measure the shift amount between the driven opening 42 and the stationary opening 22 in the display area 18. However, by measuring the distance d between the edge 26 of the dummy opening 24 and the driven opening 42 in the peripheral area 20, the shift amount between the driven opening 42 and the stationary opening 22 in the display area 18 can be detected.

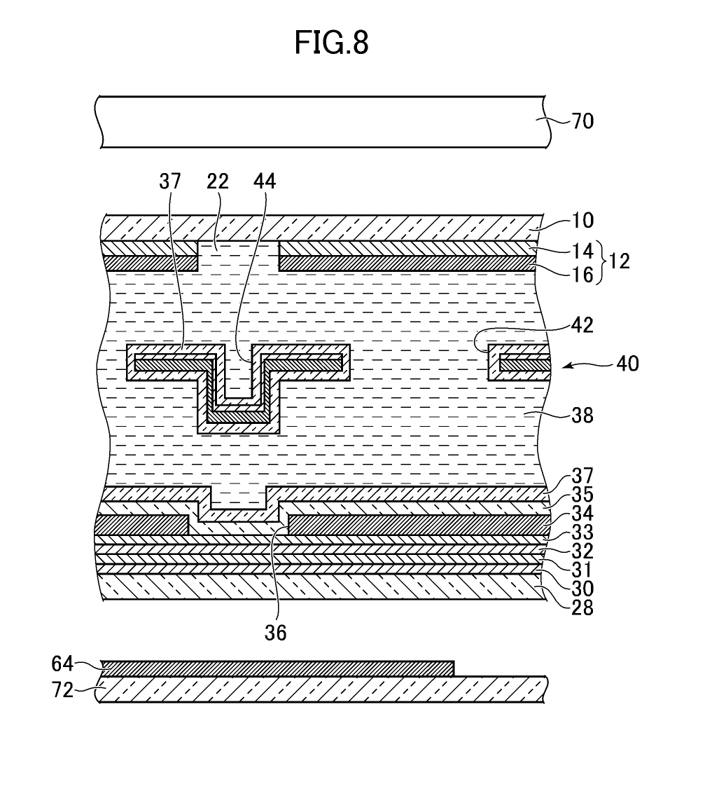

FIG. 8 is a diagram for explaining an electronic apparatus incorporating the display device according to the present embodiment. As the electronic apparatus, a smartphone is assumed, for example. The light used for the display of an image in the electronic apparatus is supplied from a backlight 70 as shown in FIG. 8. The backlight 70 can also be disposed outside the first substrate 10 as shown in FIG. 8, or can be disposed outside the second substrate 28 as a modified example.

Further, in the display device according to the present embodiment, the light is transmitted through the peripheral area 20 as described above. Therefore, as shown in FIG. 8, it is preferable to provide a light-blocking layer 64 (a printed section) to a cover substrate 72 for covering the display area 18 and the peripheral area 20 of the display device so as to cover the peripheral area 20.

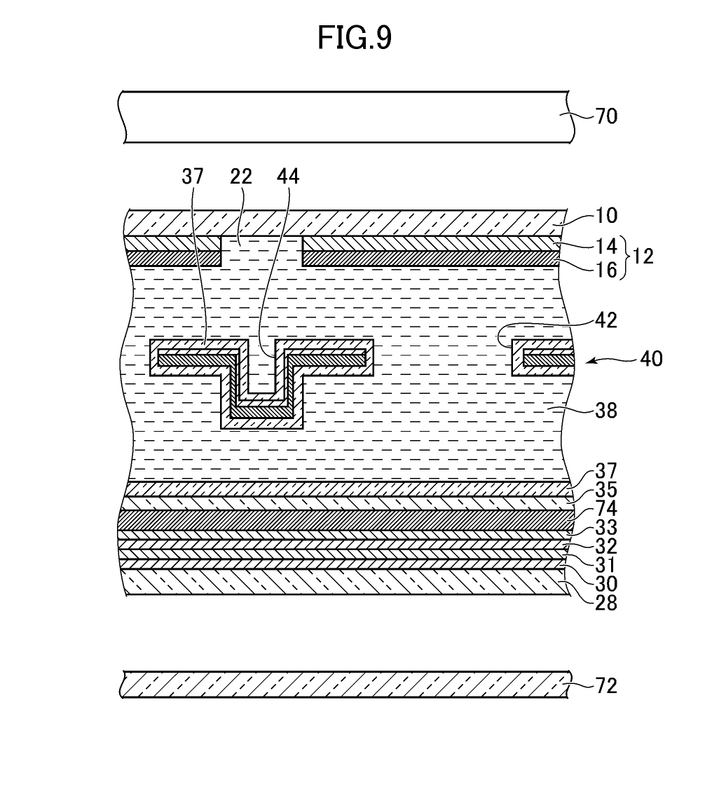

Alternately, as a modified example, it is also possible to form an internal light-blocking plate 74 provided to the second substrate 28 so as not to be provided with the opening in the peripheral area 20 instead of providing the printed section to the cover substrate 72 as shown in FIG. 9. In this case, since the light from the backlight 70 is not transmitted in the peripheral area 20, the distance between the edge 26 of the dummy opening 24 and the driven opening 42 is measured in the peripheral area 20 using the light, which is transmitted through the first substrate 10, and is then returned by being reflected by the shutter 40.

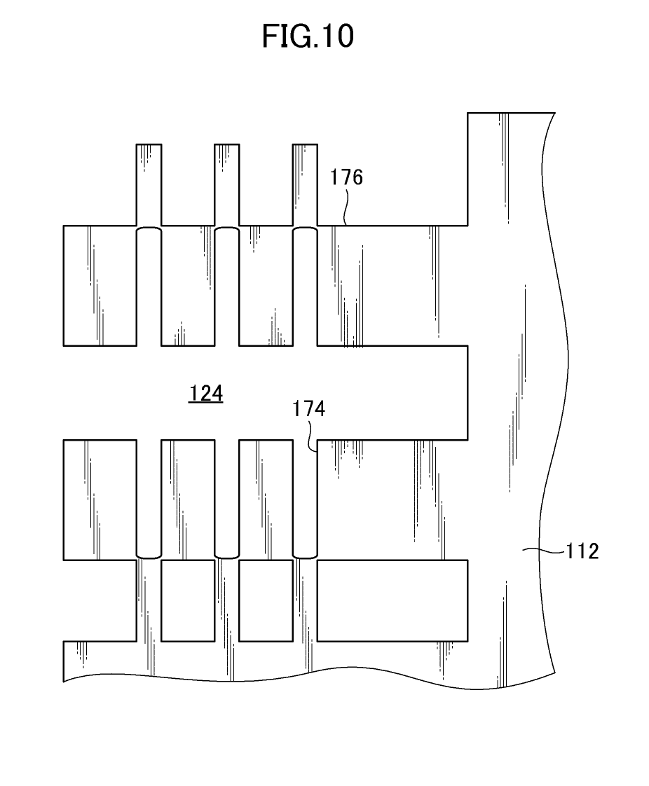

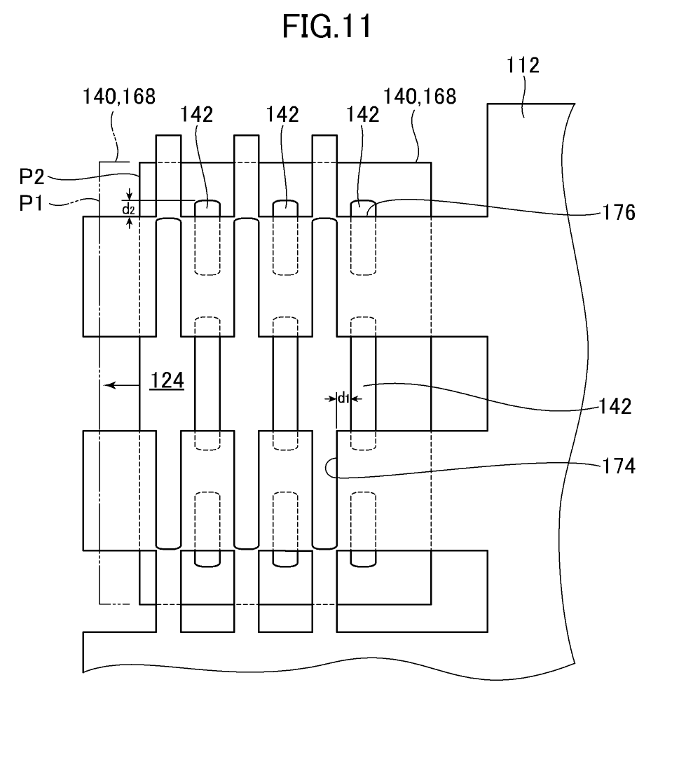

FIG. 10 is a diagram showing the dummy openings according to the modified example. FIG. 11 is an enlarged view showing the positions of the dummy openings and the driven openings according to the modified example.

In FIG. 11, a second shutter 168 is located at the second position P2 (the light-blocking position in the display area) in the peripheral area. In this case, the edge of a light-blocking film 112 includes a first edge 174 overlapping the substrate of the second shutter 168 and a second edge 176 overlapping a driven opening 142 of the second shutter 168.

The edge of the dummy opening 124 includes the first edge 174. In the case in which a shutter 140 in the peripheral area is located at the second position P2, the first edge 174 is located at a position shifted in the direction (the driving direction of the shutter 140) between the first position P1 and the second position P2 from the edge of the driven opening 142. In contrast thereto, the direction in which the first edge extends is perpendicular to the driving direction of the shutter 140. Therefore, by measuring the distance d₁ (the distance in the driving direction of the shutter 140) between the first edge 174 of a dummy opening 124 and the driven opening 142 (in detail, the nearest edge thereof to the first edge 174), the shift amount between the driven opening 142 and the stationary opening can be detected in the display area having the correlative relationship. The small shift amount shows the fact that the sufficient light blocking is not assured.

The edge of the dummy opening 124 includes the second edge 176. The second edge 176 is located at a position shifted in the extending direction of the driven opening 142 from the edge of the driven opening 142 if the shutter 140 in the peripheral area is located at the second position P2. In other words, the second edge 176 extends in the driving direction of the shutter 140. Therefore, by measuring the distance d₂ (the distance in the length direction of driven opening 142) between the second edge 176 of the dummy opening 124 and the driven opening 142 (in detail, the nearest edge thereof to the second edge 176), the shift amount of the shutter 140 in this direction can be detected.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A display device comprising:
a first substrate having a light transmissive property;
a light-blocking film provided to the first substrate;
a second substrate having a light transmissive property, disposed so as to be opposed to the first substrate with a space;
a plurality of shutters provided to the second substrate; and
a plurality of drive sections provided to the second substrate, and adapted to move the respective shutters between a first position and a second position,
wherein an area where the first substrate and the second substrate overlap each other includes a display area and a peripheral area surrounding the display area,
the plurality of shutters are arranged in the display area and the peripheral area,
each of the shutters has at least one driven opening moving in conjunction with a movement of the shutter,
a whole of the plurality of shutters has a plurality of the driven openings,
the light-blocking film is formed in the display area and the peripheral area,
the light-blocking film has a plurality of stationary openings in the display area so as to correspond to the driven openings in the display area,
each of the shutters in the display area makes the driven opening and the stationary opening be communicated with each other to transmit light at the first position, and is disposed so that the driven opening and the stationary opening are shifted from each other to block the light at the second position, and
the light-blocking film has, in the peripheral area, a dummy opening adapted to partially expose at least one of the shutters arranged in the peripheral area.

2. The display device according to claim 1, wherein
the plurality of driven openings are arranged with regularity in the entire display area and peripheral area,
the plurality of stationary openings are arranged with regularity corresponding to the regularity of the plurality of driven openings, and
in a case in which the plurality of shutters are located at the second position, a distance between the driven opening and an edge of the dummy opening in the peripheral area and a distance between the driven opening and a part of an edge of the stationary opening in the display area have a correlative relationship with each other.

3. The display device according to claim 2, wherein
the edge of the dummy opening includes an edge formed of a part of an edge of the stationary opening, which is assumed to be arranged in the peripheral area with the regularity of the plurality of stationary openings.

4. The display device according to claim 1, wherein
in a case in which the plurality of shutters are located at the second position, a distance between the driven opening and an edge of the dummy opening in the peripheral area and a distance between the driven opening and a part of an edge of the stationary opening in the display area are equal to each other.

5. The display device according to claim 1, wherein
an edge of the dummy opening is a part of the stationary opening.

6. The display device according to claim 1, wherein
the driven openings are each formed so as to extend in a direction intersecting with a direction between the first position and the second position, and
in a case in which the shutter in the display area is located at the second position, the stationary opening in the display area is located at a position shifted from the driven opening in a direction between the first position and the second position.

7. The display device according to claim 6, wherein
in a case in which the shutter in the peripheral area is located at the second position, an edge of the dummy opening is located at a position shifted from an edge of the driven opening in the direction between the first position and the second position.

8. The display device according to claim 6, wherein
in the case in which the shutter in the peripheral area is located at the second position, an edge of the dummy opening is located at a position shifted from an edge of the driven opening in a direction in which the driven opening extends.

9. The display device according to claim 6, wherein
an edge of the dummy opening includes a first edge and a second edge,
in a case in which the shutter in the peripheral area is located at the second position, the first edge is located at a position shifted from an edge of the driven opening in the direction between the first position and the second position, and
in the case in which the shutter in the peripheral area is located at the second position, the second edge is located at a position shifted from an edge of the driven opening in a direction in which the driven opening extends.

10. The display device according to claim 1, wherein
the shutters in the peripheral area include a first shutter and a second shutter, and
the light-blocking film is formed so as to always cover a whole of the driven opening of the first shutter irrespective of the position of the first shutter, and to expose a part of an edge of the driven opening of the second shutter from the dummy opening in a case in which the second shutter is located at the second position.

11. The display device according to claim 10, wherein
in a case in which the second shutter is located at the second position in the peripheral area, an edge of the light-blocking film overlaps a substrate of the second shutter.

12. The display device according to claim 10, wherein
in a case in which the second shutter is located at the second position in the peripheral area, an edge of the light-blocking film overlaps the driven opening of the second shutter.

13. The display device according to claim 10, wherein
in a case in which the second shutter is located at the second position in the peripheral area, an edge of the light-blocking film includes a first edge overlapping a substrate of the second shutter and a second edge overlapping the driven opening of the second shutter.

14. The display device according to claim 1, wherein
the display area and the peripheral area are each formed to have a rectangular shape, and
the dummy opening is provided to each of four corners of the peripheral area.
